(19) United States
(12) Patent Application Publication
(10) Pub. No.: US 2014/0251590 A1
(43) Pub. Date: Sep. 11, 2014

(54) SEAL SUPPORT SYSTEM

(71) Applicant: Christopher Iveson, Sheffiedl (GB)

(72) Inventor: Christopher Iveson, Sheffiedl (GB)

(21) Appl. No.: 13/790,165

(22) Filed: Mar. 8, 2013

(51) Int. Cl. F16J 15/16

(52) U.S. Cl. CPC F16J 15/162
USPC 165/287

(57) ABSTRACT

An apparatus and method for preventing the temperature of liquid inside a seal support system from falling below the freezing point of the liquid while maintaining substantially constant pressure inside the seal support system, includes a pressure vessel in closed loop fluid communication with a mechanical seal. The closed loop includes a feed line to the mechanical seal and a thermostatic valve for releasing liquid when the temperature of the liquid falls below a predetermined temperature. A regulating valve supplies additional liquid to the vessel by way of an external supply line.

### BACKGROUND OF THE INVENTION

1. Technical Field of the Invention

The present invention relates to support systems, for seals, such as mechanical seals.

More particularly, the present invention is concerned with the prevention of fluid inside a seal support system from freezing while placed inside extreme cold environments.

2. Description of the Prior Art

A seal support system comprises a vessel/tank which generally contains a volume of fluid. The vessel is piped to a sealing device on a pump, mixer or piece of rotating equipment. Generally there is a return pipe that is connected back to the vessel, which closes the “loop.” The fluid inside the vessel is referred to in the industry as barrier/buffer fluid.

A mechanical seal, which is supported by the seal support system, generally comprises a rotating member attached to the pump shaft and a stationary member attached to the pump housing. The rotating member is in direct contact with the stationary member, which provides the seal. A basic operating principle of mechanical seals is that they require a “fluid film” that provides a lubricant between the stationary and rotating members. A barrier/buffer fluid inside the seal support system generally provides the fluid film. The seal support system will be subject to a loss of pressure over time. Because of this, it is not uncommon for a seal support system to have a fluid feed line entering the vessel, generally originating from a mains water supply. The purpose of this fluid feed line is to ensure that the correct level of barrier/buffer fluid is maintained inside the seal support system.

Commonly used on seal support systems are other items of equipment that perform various duties. Some examples of these are pressure regulators and extra pieces of cooling equipment that help cool the barrier/buffer fluid.

Under extreme cold conditions, the barrier/buffer fluid is prone to a drop in temperature, causing the liquid inside the system to freeze. If the barrier/buffer fluid does freeze, this has the potential to have a catastrophic effect on the seal, as it will starve the seal faces of the ‘fluid film’ causing it to fail completely in a short time.

### SUMMARY OF THE INVENTION

According to the present invention, there is provided an apparatus that prevents the temperature of a liquid inside a seal support system from falling below the freezing point of the liquid, while maintaining substantially constant pressure inside the seal support system. The apparatus of the present invention comprises a vessel, a feed line capable of providing a closed loop fluid communication between the vessel and a mechanical seal, a thermostatic valve positioned in the closed loop seal support system and operable for releasing a liquid from the seal support system when the temperature of the liquid falls below a predetermined temperature, means for supplying liquid to the vessel via an external supply line, and a regulatory device for supplying further liquid to the seal support system.

Accordingly, the apparatus of the invention measures the temperature of the liquid at the coolest point in the system, which is generally accepted to be the barrier feed line into the mechanical seal. As the temperature of the liquid in this area drops to approach freezing point, the system releases the liquid to drain. This action causes a drop in pressure inside the seal support system, which is replaced with liquid from a liquid supply line.

The apparatus of the present invention comprises in its simplest form:
A pressure vessel;
A mechanical seal;
A fluid feed line into said pressure vessel from an external source;
A pressure regulator regulating the fluid from the fluid feed line into the pressure vessel;
Pipe work feeding fluid from said pressure vessel into said mechanical seal (barrier inlet) and back from said mechanical seal into said vessel (barrier outlet); and,
A primary thermostatic control valve.

Preferably, the primary thermostatic control valve is attached to the mechanical seal on the barrier inlet side of the mechanical seal, which is generally accepted to be the coolest area on the seal support system. By way of clarity, “attached” is defined in this specification to mean either directly to, or by way of, a connecting member, such as a T-piece or any other relevant fitting.

Preferably, the thermostatic control valve is connected to the pipe work so that it presents no restriction to the flow of the liquid through the system.

Preferably, the primary thermostatic control valve releases liquid inside the seal support system as the temperature inside the seal support system drops close to the freezing point. As this occurs, the liquid shall be vented to drain, which causes a pressure drop inside the seal support system.

Preferably, there is present a pressure regulator positioned on the liquid feed line to the pressure vessel, which detects a pressure drop inside the seal support system, and replaces the drained liquid with replacement liquid from an external source.

Preferably, there is also present on the seal support system a secondary thermostatic control valve adjacent to the pressure regulator in the liquid feed line on the opposite side of the pressure vessel, so that the pressure regulator is positioned between the pressure vessel and the secondary thermostatic control valve. The purpose of the secondary thermostatic control valve is to prevent the liquid in the liquid feed line from freezing. Preferably, this is achieved by again sensing the temperature of the liquid inside the liquid feed line and releasing the liquid as it approaches freezing point. As this occurs, the liquid shall be vented to drain, which shall be replaced by the liquid from the external source.

The present invention also provides a method for preventing the temperature of liquid inside a seal support system from falling below the freezing point of the liquid while maintaining substantially constant pressure inside the seal support system. The method comprises the steps of providing a vessel in closed loop fluid communication with a mechanical seal, the closed loop including a feed line from the vessel to the mechanical seal, supplying fluid to the vessel via an external liquid supply line, and controlling the liquid supply by a regulating valve, the valve being portioned inside the feed line.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 shows a schematic drawing example of a seal support system, including a mechanical seal and a mechanism which prevents the fluid inside the system from freezing, and which includes a thermostatic valve positioned in the barrier feed line, as well as in the liquid feed line to the vessel; and,

FIG. 2 shows a schematic drawing example of an alternative arrangement of a seal support system, whereby the thermostatic control valves are positioned at the end of a connector pipe, which allows the liquid being vented to be appropriately angled into a dedicated drain source.

### DETAILED DESCRIPTION OF THE DRAWING FIGURES AND PREFERRED EMBODIMENTS

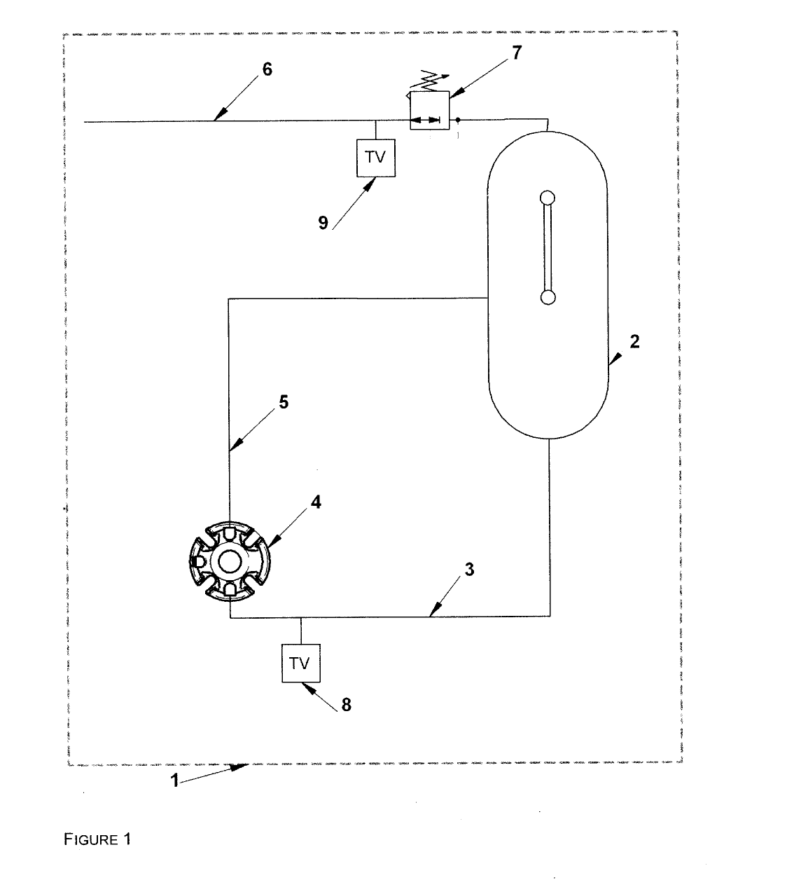

FIG. 1 shows a schematic drawing of a seal support system 1. Said seal support system 1 comprises a pressure vessel 2 that houses a volume of liquid. Attached to said pressure vessel 2 is a barrier fluid inlet 3, which feeds liquid to the mechanical seal 4, which is then returned back to said pressure vessel 2 through the barrier fluid outlet 5.

Attached to said pressure vessel 2, there is also present a liquid feed line 6, which is regulated into the pressure vessel 2 by a pressure regulator 7; the purpose of which is to control the pressure and volume of liquid inside said pressure vessel 2.

There is also present a primary thermostatic valve 8, which is positioned inside said barrier fluid inlet 3. The purpose of said primary thermostatic valve 8 is to protect the liquid inside said seal support system 1 from freezing. This is most likely to occur while the mechanical seal 4 is stationary (not in use.) The primary thermostatic valve 8 operates by sensing the temperature of the liquid inside the barrier fluid inlet 3 and as the temperatures of the liquid drops, because of external factors, to approaching its freezing point, the primary thermostatic valve 8 automatically opens to release the freezing liquid from said seal support system 1. This creates a pressure drop inside said seal support system 1, which is sensed by the pressure regulator 7, which reacts by releasing liquid from the liquid supply line 6 into the pressure vessel 2, thus replacing the liquid vented by the primary thermostatic valve 8. This operation prevents liquid inside said seal support system 1 from freezing.

A secondary thermostatic valve 9 is positioned inside said liquid supply line 6, the purpose of which is to prevent the liquid inside said liquid supply line 6 from freezing. This is most likely to occur while the mechanical seal 4 is in dynamic operation. The secondary thermostatic valve 9 operates by sensing the temperature of the liquid inside the liquid supply line 6 and as the liquid approaches freezing point, said secondary thermostatic valve 9 automatically opens to release the freezing liquid from liquid supply line 6. This liquid is then replaced by an external source further up the liquid supply line 6.

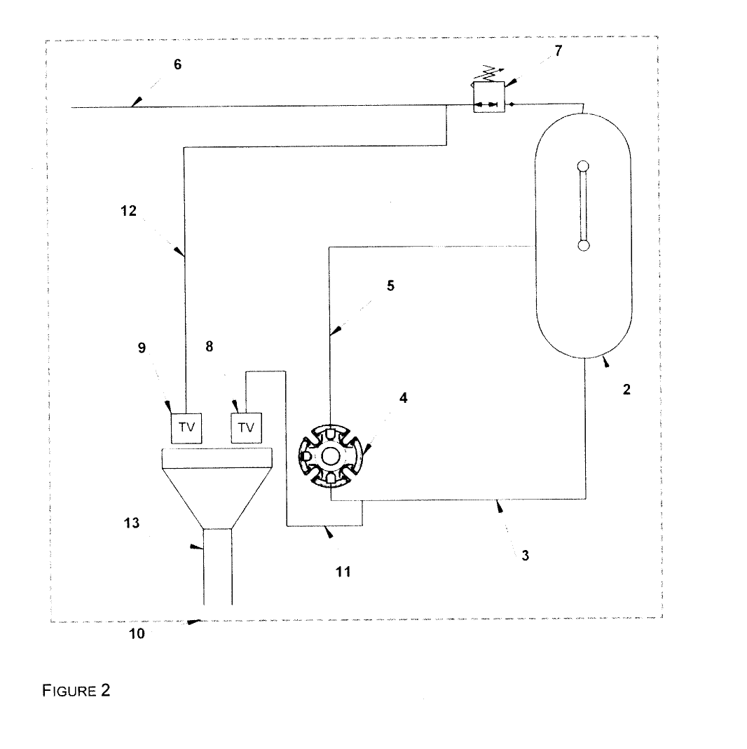

FIG. 2 shows a schematic of an alternative seal support system 10. The alternative seal support system is identical to the foregoing preferred embodiment of seal support system 1, except that there is present a primary connecting pipe 11 connecting the primary thermostatic valve 8 to the barrier fluid inlet 3 and also a secondary connecting pipe 12 connecting the secondary thermostatic valve 9 to the liquid supply line.

The purpose of both the primary connecting pipe 11 and secondary connecting pipe 12 is to allow the liquid inside the alternative preferred embodiment of seal support system 10 to be effectively piped to an appropriate drain 13.

While only several embodiments of the present invention have been shown and described, it will be obvious to those skilled in the art that many modifications may be made to the present invention without departing from the spirit and scope thereof.

What is claimed is:

1. An apparatus for preventing a temperature of a liquid inside a seal support system from falling below a freezing point of the liquid, while maintaining substantially constant pressure inside said seal support system, said apparatus comprising:
a vessel;
a feed line capable of providing a closed loop fluid communication between the vessel and a mechanical seal;
a thermostatic valve positioned in the closed loop of said seal support system and operable for releasing a liquid from said seal support system when a temperature of said liquid falls below a predetermined temperature;
means for supplying liquid to said vessel via an external supply line; and,
a regulatory device for supplying additional liquid to said seal support system.

2. The apparatus according to claim 1, wherein said thermostatic valve, when in use, is positioned adjacent to the mechanical seal.

3. The apparatus according to claim 2, wherein said thermostatic valve, when in use, is attached to a connecting member adjacent to the mechanical seal.

4. The apparatus according to claim 2, wherein said thermostatic valve is attached directly to the mechanical seal.

5. The apparatus according to claim 1, further comprising an additional thermostatic valve positioned inside said external supply line.

6. The apparatus according to claim 5, wherein said additional thermostatic valve is positioned adjacent to said regulating device, which is, in turn, adjacent to said vessel.

7. The apparatus according to claim 5, wherein said additional thermostatic valve is attached to a connecting member, which is to said regulating device.

8. The apparatus according to claim 5, wherein said additional thermostatic valve is attached directly to said regulating device.

9. The apparatus according to claim 1, wherein the liquid is water.

10. A method for preventing the temperature of liquid inside a seal support system from falling below a freezing point of the liquid while maintaining substantially constant pressure inside said seal support system, the method comprising the steps of:
providing a vessel in closed loop fluid communication with a mechanical seal, said closed loop including a feed line from said vessel to said mechanical seal;
supplying fluid to said vessel via an external liquid supply line; and,
controlling the liquid supply by a regulating valve, said regulating valve being portioned inside said feed line.
